(19) United States
(12) Patent Application Publication
(10) Pub. No.: US 2026/0230662 A1
(43) Pub. Date: Aug. 6, 2026

(54) JUST-IN-TIME TRANSCODING FOR LIVE MEDIA STREAMING INCLUDING HTTP LIVE STREAMING (HLS)

(71) Applicant: Dropbox, Inc., San Francisco, CA (US)

(72) Inventors: Pradeep Kumar Goudagunta, Austin, TX (US); Andrew Cheung, Seattle, WA (US); Benjamin Corneau, Essex, VT (US); Tejas Patel, Austin, TX (US); Daniel Wagner, Oxford (GB); Kseniia Korotenko, Cambridge, MA (US); Binoy Dash, Redmond, WA (US)

(21) Appl. No.: 19/044,119

(22) Filed: Feb. 3, 2025

(51) Int. Cl. H04N 21/2343; H04N 19/40; H04N 21/231; H04N 21/234; H04N 21/2743

(52) U.S. Cl. CPC H04N 21/234309; H04N 19/40; H04N 21/23106; H04N 21/23406; H04N 21/2743

(57) ABSTRACT

A content management system streams media items to client devices. The content management system stores a master (or uploaded version) of a video file in a first format (e.g., a first resolution and compression format) and receives a request to stream the video file to a client device using a second format. The video segments from the master are transcoded and stored in a buffer/cache on the content management system and streamed therefrom to the client device. Just-in-time transcoding is performed by waiting until the amount of transcoded segments that are stored in the buffer and have not yet been streamed falls below a predefined threshold before fetching another chunk of video segment from block storage and transcoding them. Transcoding of the first part of the video file is enabled before the master is completely uploaded partitioning the upload units to place the upload boundaries between video segments.

### FIELD

The embodiments pertain in general to content management systems, and more specifically to a content management system streaming media items to client devices using just-in-time transcoding.

### BACKGROUND

Content management systems enable users to access content items from multiple client devices. A user provides content items, such as videos or audio files to a content management system for storage. At any point, the user or another user with permission may request to access a stored content item from the content management system. When such a request is made for a video file that is adapted for streaming, the content management system streams the video file to the user's client device so that the client device can start playing the content item.

Transcoding is used when the stored video file is stored in a different format than the streaming format. Transcoding converts the video file from the stored format to the streaming format.

### BRIEF SUMMARY

A content item stored on a content management system can be a media item such as a video file. For example, the content management system can stream segments of the video file to one or more client devices. Often the uploaded video file (i.e., the master video file) will have a different format (e.g., resolution and/or video compression standard) than the streaming format used by the video player on the client device to which it is being streamed, necessitating the video file to be transcoded before it can be streamed. Transcoding to different formats and storing the transcoded video can consume significant computational and storage resources.

Sometimes video files can be uploaded but not viewed. In these cases, computational and storage resources can be conserved by not transcoding the video file. The systems and methods disclosed herein provide just-in-time transcoding by only transcoding parts of the video that are likely to be viewed in the near future.

Thus, computational and storage resources can be freed up by only transcoding the video file on an as-needed basis. For example, a user may view only a part of the video file, in which case, only the portion of the video file that is viewed needs to be transcoded. This result can be achieved by incrementally transcoding parts of the master of the video file as they are needed. For example, the video file can be transcoded in one-minute segments, such that when a certain amount of time (e.g., 30 seconds) remains in the currently streaming segment, the next one-minute segment is fetched from block storage and transcoded.

Additional computational resources can be economized by storing the transcoded portions of the video to be used later, rather than transcoding them from the master of the video file each time they are requested by a user. For example, the transcoded portions of the video can be stored in a cache. Thus, the system can first inquire whether a transcoded copy of the video file in the desired format and resolution is already in storage, and, only when the transcoded copy is not found, does the system transcode the master to generate a copy in the desired format and resolution.

In some aspects, the techniques described herein relate to a method of transcoding video data, the method including: storing, at a content management system, a master of a video file, the master having a first format including a first resolution and in a first video compression format; receiving a request to stream the video file in a second format to a client device; fetching respective sets of video segments of the master in increments corresponding to a first time duration, a respective set of the video segments having a video-play duration defined by the first time duration, wherein a first set of the video segments comes before a second set of the video segments, and the second set is fetched after an amount of the first set video segments remaining to be streamed to the client device is less than a second time duration; transcoding from the first format to the second format the respective sets of video segments as they are fetched to provide transcoded segments for the respective set of the video segments; and streaming the transcoded segments to the client device.

### BRIEF DESCRIPTION OF THE DRAWINGS

FIG. 1 illustrates an example of a content management system and client devices in accordance with some embodiments of the present technology.

FIG. 2 illustrates a block diagram of an environment of a content management system in accordance with some embodiments of the present technology.

FIG. 3 illustrates a flow diagram for a method of transcoding and streaming media data in accordance with some embodiments of the present technology.

FIG. 4A illustrates an example of a front end flow for a file-management server in accordance with some embodiments of the present technology.

FIG. 4B illustrates an example of a back end flow for a file-management server in accordance with some embodiments of the present technology.

FIG. 5 illustrates a sequence diagram for transcoding and streaming media data in accordance with some embodiments of the present technology.

FIG. 6 illustrates a sequence diagram for transcoding and streaming media data when some video segments are already transcoded in accordance with some embodiments of the present technology.

FIG. 7 illustrates a flow diagram for a method for uploading, transcoding, and streaming media data in accordance with some embodiments of the present technology.

FIG. 8 illustrates placing upload boundaries between video segments to facilitate transcoding and streaming segments of the video file before the upload of the entire video file is complete in accordance with some embodiments of the present technology.

FIG. 9A illustrates a timeline for an example of uploading and transcoding a video when the upload boundaries are not placed between video segments in accordance with some embodiments of the present technology.

FIG. 9B illustrates a timeline for an example of uploading and transcoding a video when the upload boundaries are placed between video segments in accordance with some embodiments of the present technology.

FIG. 10 illustrates a flow diagram for a method for transcoding and streaming media data simultaneously with uploading the media data in accordance with some embodiments of the present technology.

FIG. 11 illustrates a sequence diagram for an example of transcoding media data simultaneously with uploading the media data in accordance with some embodiments of the present technology.

FIG. 12 shows an example of a computing system for implementing some embodiments of the present technology.

### DETAILED DESCRIPTION

The figures depict an embodiment for purposes of illustration only. One skilled in the art will readily recognize from the following description that alternative embodiments of the structures and methods illustrated herein may be employed without departing from the principles described herein.

### DETAILED DESCRIPTION

The systems and methods disclosed herein improve the efficiency of content management systems that store media items, which can be streamed from the content management system. Although the systems and methods disclosed herein can be used with different types of media items such as audio files, video files, or multi-page documents, the disclosure illustrates the systems and methods disclosed herein using the non-limiting example of video files as the media items, without loss of generality. The different types of media items can be transcoded incrementally. For example, audio files can be streamed such that parts of the audio file are transcoded in increments. Further, multi-page documents can be viewed (and transcoded) in increments of an integer number of pages.

When a video file is streamed from a content management system to a client device, a master of the video file can be transcoded to the format and resolution of the video player on the client device. However, not all video files uploaded to the content management system will be streamed to user devices. Often, a video file will be uploaded to a content management system, and the video file is not thereafter streamed or otherwise viewed. In this case, the video file need not be transcoded, freeing up computational and storage resources that would have been used to perform the transcoding process and storing the transcoded video.

Further, computational and storage resources can be freed up by only transcoding the video file on an as-needed basis. For example, a user may view only a part of the video file, in which case, only the portion of the video file that is viewed needs to be transcoded. This result can be achieved by incrementally transcoding parts of the master of the video file as they are needed. For example, the video file can be transcoded in one-minute segments, such that when a certain amount of time (e.g., 30 seconds) remains in the currently streaming segment, the next one-minute segment is fetched from block storage and transcoded.

Additional computational resources can be economized by storing the transcoded portions of the video to be used later, rather than transcoding them from the master of the video file each time they are requested by a user. Thus, the system can first inquire whether a transcoded copy of the video file in the desired format and resolution is already in storage. Only when the transcoded copy is not found, does the system transcode the master to generate a copy in the desired format and resolution.

According to certain non-limiting examples, the invention addresses issues for transcoding for HTTP Live Streaming (HLS). For example, the systems and methods disclosed herein address inefficiencies due to transcoding video that is not played. Significant cost savings (e.g., reduced memory usage and computational load) can be realized by transcoding video in one- or two-minute chunks, rather than transcoding the entire video. Further cost savings can be realized by only transcoding video to the format and/or resolution (e.g., 480p, 720p, 1080p, etc.) corresponding to the streaming format. Just-in-time transcoding is enabled by using a file retrieval system in which video for different time intervals is stored in respective blocks that are indexed such that they can be retrieved individually. Further, the systems and methods disclosed herein for uploading video files in blocks enable streaming even before all of the video segments have been uploaded. Response times for playing the video are shortened by using API calls in the playlist to pre-warm (e.g., transcode) a beginning portion of the video before the user plays the video.

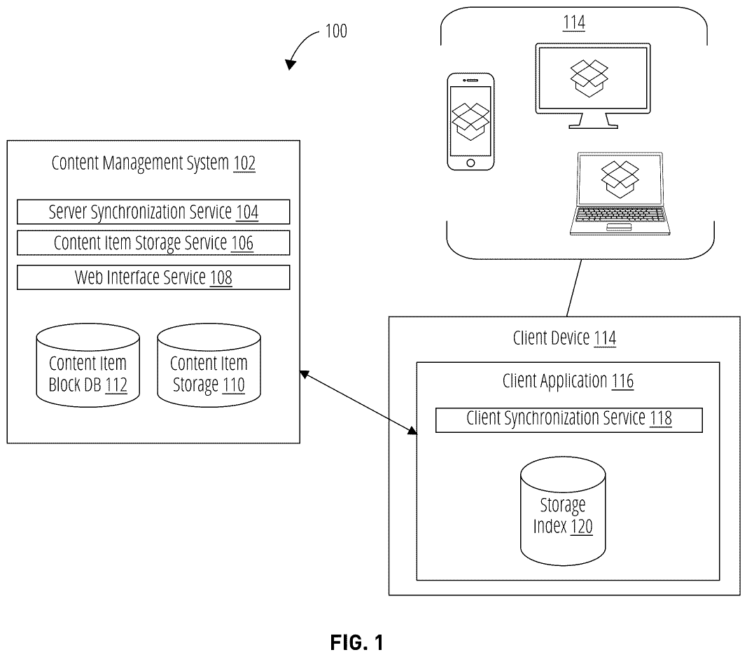

In some embodiments, the disclosed technology is deployed in the context of a content management system having content item synchronization capabilities and collaboration features, among others. An example system configuration 100 is shown in FIG. 1, which depicts content management system 102 interacting with client device 114. Although the example system depicts particular system components and an arrangement of such components, this depiction is to facilitate a discussion of the present technology and should not be considered limiting unless specified in the appended claims. For example, some components that are illustrated as separate can be combined with other components, some components can be divided into separate components, some components might not be present or needed, and additional components may be present.

### Accounts

Content management system 102 can store content items in association with accounts, as well as perform a variety of content item management tasks, such as retrieve, modify, browse, and/or share the content item(s). Furthermore, content management system 102 can enable an account to access content item(s) from multiple client devices.

Content management system 102 supports a plurality of accounts. A subject (user, group, team, company, etc.) can create an account with content management system.

### Content Item Storage

A feature of content management system 102 is the storage of content items, which can be stored in storage drive 110. A content item generally is any entity that can be recorded in a file system. Content items can be any object including digital data such as documents, collaboration content items, text files, audio files, image files, video files, webpages, executable files, binary files, content item directories, folders, zip files, playlists, albums, symlinks, cloud docs, mounts, placeholder content items referencing other content items in content management system 102 or in other content management systems, etc.

In some embodiments, content items can be grouped into a collection, which can refer to a folder including a plurality of content items, or a plurality of content items that are related or grouped by a common attribute.

In some embodiments, storage drive 110 is combined with other types of storage or databases to handle specific functions. Storage drive 110 can store content items, while metadata regarding the content items can be stored in a metadata database. Likewise, data regarding where a content item is stored in storage drive 110 can be stored in content item block database 112. Thus, content management system 102 may include more or less storages and/or databases than shown in FIG. 1.

In some embodiments, storage drive 110 is associated with at least one content item storage service 106, which includes software or other processor-executable instructions for managing the storage of content items including, but not limited to, receiving content items for storage, preparing content items for storage, selecting a storage location for the content item, retrieving content items from storage, etc. In some embodiments, content item storage service 106 can divide a content item into smaller chunks for storage at storage drive 110. The location of each chunk making up a content item can be recorded in content item block database 112. Content item block database 112 can include a content entry for each content item stored in storage drive 110. The content entry can be associated with a content item ID, which uniquely identifies a content item.

In some embodiments, content items and chunks of content items can also be identified from a deterministic hash function. This method of identifying a content item and chunks of content items can ensure that content item duplicates are recognized as such since the deterministic hash function will output the same hash for every copy of the same content item, but will output a different hash for a different content item. Using this methodology, content item storage service 106 can output a unique hash for each different version of a content item.

Content item storage service 106 can also designate or record a parent of a content item or a content path for a content item. The content path can include the name of the content item and/or folder hierarchy associated with the content item. For example, the content path can include a folder or path of folders in which the content item is stored in a local file system on a client device. In some embodiments, content item database might only store a direct ancestor or direct child of any content item, which allows a full path for a content item to be derived, and can be more efficient than storing the whole path for a content item.

While content items are stored in storage drive 110 in blocks and may not be stored under a tree like directory structure, such directory structure is a comfortable navigation structure for subjects viewing content items. Content item storage service 106 can define or record a content path for a content item wherein the “root” node of a directory structure can be any directory with specific access privileges assigned to it, as opposed to a directory that inherits access privileges from another directory.

In some embodiments, a root directory can be mounted underneath another root directory to give the appearance of a single directory structure. This can occur when an account has access to a plurality of root directories. As addressed above, the directory structure is merely a comfortable navigation structure for subjects viewing content items, but does not correlate to storage locations of content items in storage drive 110.

While the directory structure in which an account views content items does not correlate to storage locations of the content items at content management system 102, the directory structure can correlate to storage locations of the content items on client device 114 depending on the file system used by client device 114.

As addressed above, a content entry in content item block database 112 can also include the location of each chunk making up a content item. More specifically, the content entry can include content pointers that identify the location in storage drive 110 of the chunks that make up the content item.

Content item storage service 106 can decrease the amount of storage space required by identifying duplicate content items or duplicate blocks that make up a content item or versions of a content item. Instead of storing multiple copies, storage drive 110 can store a single copy of the content item or block of the content item, and content item block database 112 can include a pointer or other mechanism to link the duplicates to the single copy.

Content item storage service 106 can also store metadata describing content items, content item types, folders, file path, and/or the relationship of content items to various accounts, collections, or groups, in association with the content item ID of the content item.

Content item storage service 106 can also store a log of data regarding changes, access, etc.

### Content Item Synchronization

Another feature of content management system 102 is synchronization of content items with at least one client device 114. Client devices 114 can take different forms and have different capabilities. For example, client device 114 can be a computing device having a local file system accessible by multiple applications resident thereon. Client device 114 can be a computing device wherein content items are only accessible to a specific application or by permission given by the specific application, and the content items are typically stored either in an application specific space or in the cloud. Client device 114 can be any client device accessing content management system 102 via a web browser and accessing content items via a web interface. While example client device 114 is depicted in form factors such as a laptop, mobile device, or web browser, it should be understood that the descriptions thereof are not limited to devices of these example form factors. For example, a mobile device might have a local file system accessible by multiple applications resident thereon or might access content management system 102 via a web browser. As such, the form factor should not be considered limiting when considering client device 114's capabilities. One or more functions described herein with respect to client device 114 may or may not be available on every client device depending on the specific capabilities of the device—the file access model being one such capability.

In many embodiments, client devices 114 are associated with an account of content management system 102, but in some embodiments client device 114 can access content using shared links and do not require an account.

As noted above, some client devices can access content management system 102 using a web browser. However, client devices can also access content management system 102 using client application 116 stored and running on client device 114. Client application 116 can include a client synchronization service 118.

Client synchronization service 118 can be in communication with server synchronization service 104 to synchronize changes to content items between client device 114 and content management system 102.

Client device 114 can synchronize content with content management system 102 via client synchronization service 118. The synchronization can be platform agnostic. That is, content can be synchronized across multiple client devices of varying types, capabilities, operating systems, etc. Client synchronization service 118 can synchronize any changes (e.g., new, deleted, modified, copied, or moved content items) to content items in a designated location of a file system of client device 114.

Content items can be synchronized from client device 114 to content management system 102, and vice versa. In embodiments wherein synchronization is from client device 114 to content management system 102, a subject can manipulate content items directly from the file system of client device 114, while client synchronization service 118 can monitor directory on client device 114 for changes to files within the monitored folders.

When client synchronization service 118 detects a write, move, copy, or delete of content in a directory that it monitors, client synchronization service 118 can synchronize the changes to content item storage service 106. In some embodiments, client synchronization service 118 can perform some functions of content item storage service 106 including functions addressed above such as dividing the content item into blocks, hashing the content item to generate a unique identifier, etc. Client synchronization service 118 can index content within client storage index 120 and save the result in client storage index 120. Indexing can include storing paths plus the content item identifier, and a unique identifier for each content item. In some embodiments, client synchronization service 118 learns the content item identifier from server synchronization service 104, and learns the unique client identifier from the operating system of client device 114.

Client synchronization service 118 can use storage index 120 to facilitate the synchronization of at least a portion of the content items within client storage with content items associated with a subject account on content management system 102. For example, client synchronization service 118 can compare storage index 120 with content management system 102 and detect differences between content on client storage and content associated with a subject account on content management system 102. Client synchronization service 118 can then attempt to reconcile differences by uploading, downloading, modifying, and deleting content on client storage as appropriate.

In some embodiments, storage index 120 stores tree data structures wherein one tree reflects the latest representation of a directory according to server synchronization service 104, while another tree reflects the latest representation of the directory according to client synchronization service 118. Client synchronization service 118 can work to ensure that the tree structures match by requesting data from server synchronization service 104 or committing changes on client device 114 to content management system 102.

Sometimes client device 114 might not have a network connection available. In this scenario, client synchronization service 118 can monitor the linked collection for content item changes and queue those changes for later synchronization to content management system 102 when a network connection is available. Similarly, a subject can manually start, stop, pause, or resume synchronization with content management system 102.

Client synchronization service 118 can synchronize all content associated with a particular subject account on content management system 102. Alternatively, client synchronization service 118 can selectively synchronize some of the content items associated with the particular subject account on content management system 102. Selectively synchronizing only some of the content items can preserve space on client device 114 and save bandwidth.

In some embodiments, client synchronization service 118 selectively stores a portion of the content items associated with the particular subject account and stores placeholder content items in client storage for the remainder portion of the content items. For example, client synchronization service 118 can store a placeholder content item that has the same filename, path, extension, metadata, of its respective complete content item on content management system 102, but lacking the data of the complete content item. The placeholder content item can be a few bytes or less in size while the respective complete content item might be significantly larger. After client device 114 attempts to access the content item, client synchronization service 118 can retrieve the data of the content item from content management system 102 and provide the complete content item to client device 114. This approach can provide significant space and bandwidth savings while still providing full access to a subject's content items on content management system 102.

While the synchronization embodiments addressed above referred to client device 114 and a server of content management system 102, it should be appreciated by those of ordinary skill in the art that a user account can have any number of client devices 114 all synchronizing content items with content management system 102, such that changes to a content item on any one client device 114 can propagate to other client devices 114 through their respective synchronization with content management system 102.

### Content Item Access

Content item storage service 106 can receive a token from client application 116 that follows a request to access a content item and can return the capabilities permitted to the subject account.

In some embodiments, one or more of the services or storages/databases discussed above can be accessed using public or private application programming interfaces.

Certain software applications can access storage drive 110 via an API on behalf of a subject. For example, a software package such as an application running on client device 114, can programmatically make API calls directly to content management system 102 when a subject provides authentication credentials, to read, write, create, delete, share, or otherwise manipulate content.

A subject can view or manipulate content stored in a subject account via a web interface generated and served by web interface service 108. For example, the subject can navigate in a web browser to a web address provided by content management system 102. Changes or updates to content in the storage drive 110 made through the web interface, such as uploading a new version of a content item, can be propagated back to other client devices associated with the subject's account. For example, multiple client devices, each with their own client software, can be associated with a single account and content items in the account can be synchronized between each of the multiple client devices.

Client device 114 can connect to content management system 102 on behalf of a subject. A subject can directly interact with client device 114, for example when client device 114 is a desktop or laptop computer, phone, television, internet-of-things device, etc. Alternatively or additionally, client device 114 can act on behalf of the subject without the subject having physical access to client device 114, for example when client device 114 is a server.

Some features of client device 114 are enabled by an application installed on client device 114. In some embodiments, the application can include a content management system specific component. For example, the content management system specific component can be a stand-alone client application 116, one or more application plug-ins, and/or a browser extension. However, the subject can also interact with content management system 102 via a third-party application, such as a web browser, that resides on client device 114 and is configured to communicate with content management system 102. In various implementations, the client application 116 can present a subject interface (UI) for a subject to interact with content management system 102. For example, the subject can interact with the content management system 102 via a file system explorer integrated with the file system or via a webpage displayed using a web browser application.

In some embodiments, client application 116 can be configured to manage and synchronize content for more than one account of content management system 102. In such embodiments client application 116 can remain logged into multiple accounts and provide normal services for the multiple accounts. In some embodiments, each account can appear as folder in a file system, and all content items within that folder can be synchronized with content management system 102. In some embodiments, client application 116 can include a selector to choose one of the multiple accounts to be the primary account or default account.

### Third Party Services

In some embodiments, content management system 102 can include functionality to interface with one or more third-party services such as workspace services, email services, task services, etc. In such embodiments, content management system 102 can be provided with login credentials for a subject account at the third-party service to interact with the third-party service to bring functionality or data from those third-party services into various subject interfaces provided by content management system 102.

While content management system 102 is presented with specific components, it should be understood by one skilled in the art, that the architectural system configuration (e,g., system configuration 100) is simply one possible configuration and that other configurations with more or fewer components are possible. Further, a service can have more or less functionality, even including functionality described as being with another service. Moreover, features described herein with respect to an embodiment can be combined with features described with respect to another embodiment.

While system configuration 100 is presented with specific components, it should be understood by one skilled in the art, that system configuration 100 is simply one possible configuration and that other configurations with more or fewer components are possible.

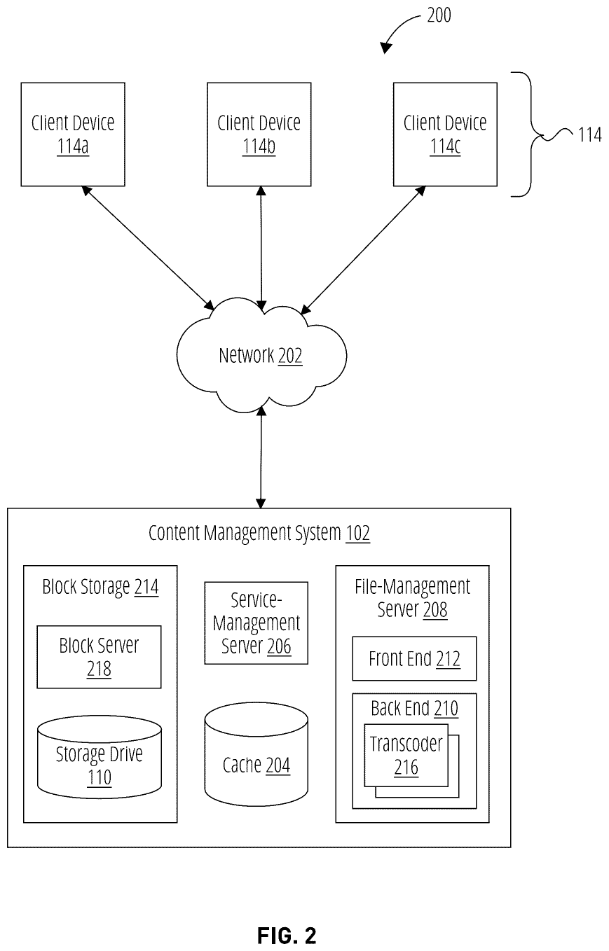

FIG. 2 is a step diagram of content management system (e.g., environment 200) according to one example. Environment 200 includes client devices (e.g., client devices 114a, client devices 114b, and client devices 114c), and content management system 102 connected to network 202. Although environment 200 is illustrated as including three client devices 114, other embodiments include fewer or more client devices 114.

FIG. 2 and the other figures use like reference numerals to identify like elements. A letter after a reference numeral, such as “114a,” indicates that the text refers specifically to the element having that particular reference numeral. A reference numeral in the text without a following letter, such as “114,” refers to any or all of the elements in the figures bearing that reference numeral.

Network 202 enables communication among the entities connected to it. In one example, network 202 is the Internet and uses standard communications technologies and/or protocols. Thus, network 202 can include links using technologies such as Ethernet, 1102.11, worldwide interoperability for microwave access (WiMAX), 3G, Long Term Evolution (LTE), digital subscriber line (DSL), asynchronous transfer mode (ATM), InfiniBand, etc. Similarly, the networking protocols used on network 202 can include multiprotocol label switching (MPLS), the transmission control protocol/Internet protocol (TCP/IP), the User Datagram Protocol (UDP), the hypertext transport protocol (HTTP), the simple mail transfer protocol (SMTP), the file transfer protocol (FTP), etc. The data exchanged over the network 202 can be represented using technologies and/or formats including the hypertext markup language (HTML), the extensible markup language (XML), etc. In addition, all or some of the links can be encrypted using conventional encryption technologies such as the secure sockets layer (SSL), transport layer security (TLS), virtual private networks (VPNs), Internet Protocol security (IPsec), etc.

According to certain non-limiting examples, each of client devices 114 can be a computer system capable of communicating with content management system 102 via network 202. Client devices 114 may be, for example, a personal computer, a mobile phone, a tablet, a personal digital assistant (PDA), or a television set-top box. Through client devices 114, users of content management system 102 can send/upload content items to content management system 102 for storage. A content item includes digital data, audio, video, images, documents, text, etc. Additionally, a content item can include a folder or other mechanism for grouping content items together with different behaviors, such as the collection of content items, playlists, albums, or videos. Certain types of content items are configured to be streamed, such as audio and video files.

Through client devices 114, users can request to access content items stored by content management system 102. A user can request to access a content item using, for example, a user interface provided by content management system 102 or a link (e.g., a uniform resource locator) generated by system 102 for accessing the item.

When client devices 114 send a request to the content management system 102 to access a content item, client devices 114 load a media player. The media player presents the requested content item as it is streamed by content management system 102 to client devices 114. In one example, the media player starts playback of a content item being streamed once it has received the initial segments (e.g., first two segments) of the content item from content management system 102.

Content management system 102 can be a computer system that allows users to provide content items for storage and allows users to access stored content items. Therefore, from a client device, a user can upload a content item to system 102 for storage and at a later time the content item may be accessed from the same or different client devices 114 operated by the same or a different user.

Each user that registers with content management system 102 can have an account with content management system 102. A registered user can upload content items to system 102 for association with his account. The user can organize the items associated with his account into different folders. Further, the user can allow other users to access content items associated with his account. To allow other users to access a content item, the user can share with the other users a share link that provides direct access to the content item. The user can also share with other users a folder that includes multiple content items uploaded by the user to his account. The users with whom the folder was shared can access the content items included in the folder. Additionally, the users can upload content items to include in the shared folder.

When a user requests to upload a content item for storage and association with an account, content management system 102 receives the content item from the user's client devices 114. Content management system 102 stores the item in an original format. In one example, the original format is a non-streaming format. In one example, the original format is the format in which client device uploaded the item to the system 102.

When client devices 114 request the stored content item from content management system 102, content management system 102 sends via streaming to client devices 114 segments into which the content item has been partitioned. Content management system 102 partitions the item into an ordered sequence of multiple segments. The order of the segments is according to the order in which the segments are presented by a media player. For example, the first segment in the sequence is presented first and the last segment in the sequence is presented last.

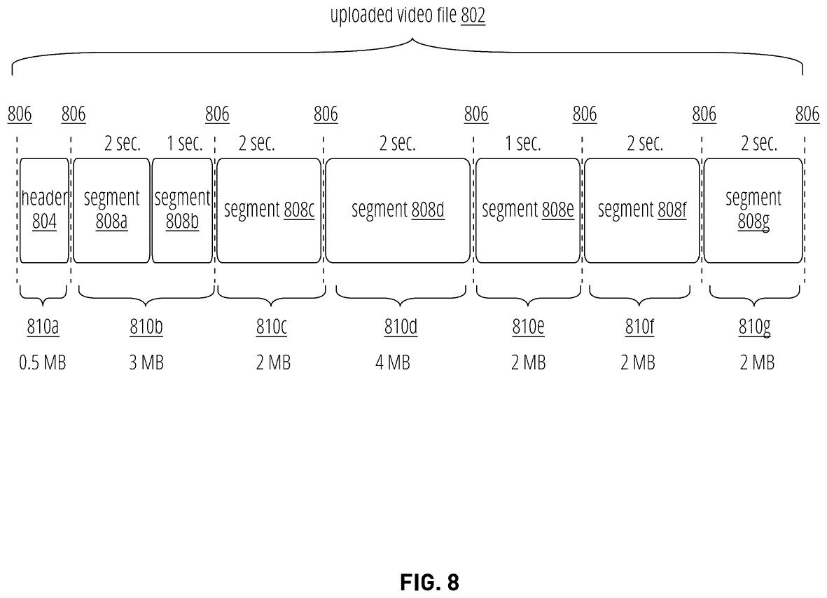

The content item can be partitioned so that the segments in the sequence are not all the same length (i.e., the length of the segments varies). The length of a segment may refer, for example, to its duration, number of frames, playback time, or size (e.g., number of bytes). An initial portion of the sequence comprises a predetermined number of the initial segments configured to be smaller in length than the other segments in the sequence. For example, the initial segments in the sequence may each have a playback time/duration of 2 seconds, while the other segments in the sequence may have a playback time of either 3, 4 or 5 seconds. Examples of variable length segments are shown in FIG. 8, which shows that the variable length segments can be selected such that uploaded boundaries coincide with the boundaries between segments, thereby enabling the video file to be processed (e.g., transcoded) and streamed to a client device even before the entire file being uploaded.

According to certain non-limiting examples, the initial segments can be shorter such that they can be processed rapidly, shortening the latency between when they are fetched and when they are ready to be streamed. For example, the number and length of the initial segments can be determined by the operator of content management system 102, and can be based on the file format used for the content items, the performance characteristics of the codec(s) available on client devices 114, the latency or other transmission characteristics of network 202. the number and length of the initial segments are selected to allow client devices 114 to rapidly decode and start playback of the content item with a minimal amount of delay from the time a client device requests the content item from content management system 102.

When the initial segments are small in length and the media player of client device 114 only needs these segments to start playback of the item, a client device is able to quickly receive the segments from system 102, decode them and start playback of the item. The length of the other segments in the subsequent portion of the sequence is such that they are longer in length than the initial segments but the player can still receive these segments fast enough to prevent the player from stopping or stuttering during playback.

In one example, content management system 102 partitions the content item and transcodes at least some of the segments from the original format to the streaming format prior making the item available to client devices 114 for access. In another embodiment, system 102 partitions the item and transcodes the segments when the request for the item is received from client devices 114. A streaming format is a format that is used by the video player on a client device when streaming a content item to the client device.

As illustrated in FIG. 2, content management system 102 includes service-management server 206, block storage 214, file-management server 208, transcoders 216, and cache 204. Block storage 214 includes block server 218 and storage drive 110. File-management server 208 includes front end 212 and back end 210, which includes transcoders 216. Examples of service-management server 206 can include, for example, METASERVER and ATLAS software by DROPBOX. An example of file-management server 208 can include, for example, RIVIERA software by DROPBOX. An example of block server 218 can include, for example, MAGIC POCKET software by DROPBOX.

Those of skill in the art will recognize that other embodiments of content management system 102 can have different and/or other components than those described herein, and that the functionalities can be distributed among the components in a different manner. While components of content management system 102 are described as separate computer servers, in some embodiments each of these servers may be implemented as a module of a single server.

According to certain non-limiting examples, service-management server 206 processes requests received from client devices 114 regarding content items and is one means for performing this function. In one example, upon request from a user having an account with system 102, service-management server 206 provides a user interface to client devices 114 that allows the user to see different content items associated with the user's account. In one example, prior to providing the user interface, service-management server 206 requires that the user provide authentication information (e.g., a login and password) associated with the account.

Through the user interface, the user can request to upload new content items for storage and can request to access stored items associated with the user's account. When the user requests to upload a content item for storage, service-management server 206 receives the content item and metadata associated with the item from client devices 114 of the user. In one example, the content item is received in an original format. In one example, the metadata associated with the item includes one or more of the following: the name of the content item, an indication as to one or more accounts with which the item should be associated, a folder in which the item is to be included, and an indication as to the user that requested the upload.

According to certain non-limiting examples, service-management server 206 forwards the content item and the metadata to block server 218 for storage in storage drive 110. Storage drive 110 stores content items in the original format. Service-management server 206 additionally determines whether to transcode a portion of the content item from the original format to a streaming format before making the item available for access by one or more client devices 114. The process of transcoding before making a content item available for access is referred to as “pre-warming” herein. In one example, service-management server 206 is set to pre-warm a portion of every content item that is uploaded. In another example, service-management server 206 is set so that no uploaded content item is pre-warmed.

For example, when a content item is uploaded and a preview is provided for the content item, then a portion of the beginning of the content item can be pre-warmed (i.e., transcoded before a request to initiate streaming). As discussed above, in many cases, video file are uploaded but never viewed (e.g., video from surveillance cameras might be uploaded but only be viewed after a security incident). In this case, pre-warming any of the video file would be inefficient, and a better approach is to wait for the video to be accessed and then transcode the video file only when it has been accessed.

Further, in some cases, a user can access a folder storing the video file and a preview of the video file can be pre-warmed (e.g., the first 30 seconds of the video can be transcoded), but transcoding/pre-warming the entire video file would be inefficient. In view of these inefficiencies arising from pre-warming/transcoding parts of the video file that are unlikely to be viewed, the systems and methods disclosed herein use transcoding/pre-warming on a just-in-time basis, such that segments of the video file are transcoded when a predefined amount of transcoded video data remaining to stream (e.g., the amount of transcoded video that is buffered but not yet streamed to the user device) falls below a predefined threshold.

For example, the first minute of video data can be pre-warmed by fetching one minute's worth of the master video file and transcoding it from the original format to the streaming format. This first minute of transcoded video can be buffered by storing it in cache 204 and streamed to a requesting client device. The predefined threshold may be triggered when the remaining transcoded video to be streamed falls below thirty seconds. In this case, when thirty seconds of the first has been streamed and thirty seconds of transcoded video remains to be streamed, file-management server 208 can fetch from block storage 214 the second minute of the master video file and transcode it from the original format to the streaming format. This second minute of transcoded video can be buffered by storing it in cache 204 and streaming it to a requesting client device. After one more minute of transcoded video has been streamed, thirty seconds of transcoded video remains to be streamed and file-management server 208 fetches the third minute of the master video file, transcodes it into the streaming format, and buffers the third transcoded so that it can be streamed. This process repeats until the entire video has been streamed or until the user stops streaming the video file.

The example of transcoding the video file in one-minute chunks is non-limiting. For example, the chunks can be larger or smaller. Additionally, the size of the chunks can be a range of sizes, such as a range of about 58 seconds to about 62 seconds. When using variable-length video segments, even when the chunks of video data are nominally one-minute chunks, the actual size of the chunks might be about 60 seconds, rather than exactly 60 seconds.

Those of skill in the art will recognize that the example of one-minute time intervals and a thirty-second threshold for fetching and pre-warming the next set of video segments in non-limiting, and other time intervals or measures can be used for the size of chunks of the video file being pre-warmed and other thresholds can be used to trigger when these chunks of the video file are pre-warmed.

Transcoding can be a computationally intensive process. Thus, after the video data has been transcoded from the original format to the streaming format, future transcoding to the streaming format can be avoided by writing the transcoded video data from cache 204 to storage drive 110. In the future, file-management server 208 can check whether the transcoded video data already exists in storage drive 110. When the transcoded video data already exists in cache 204, file-management server 208 can use the existing transcoded video data in cache 204, rather than transcoding it from the master file each time the transcoded video file is requested.

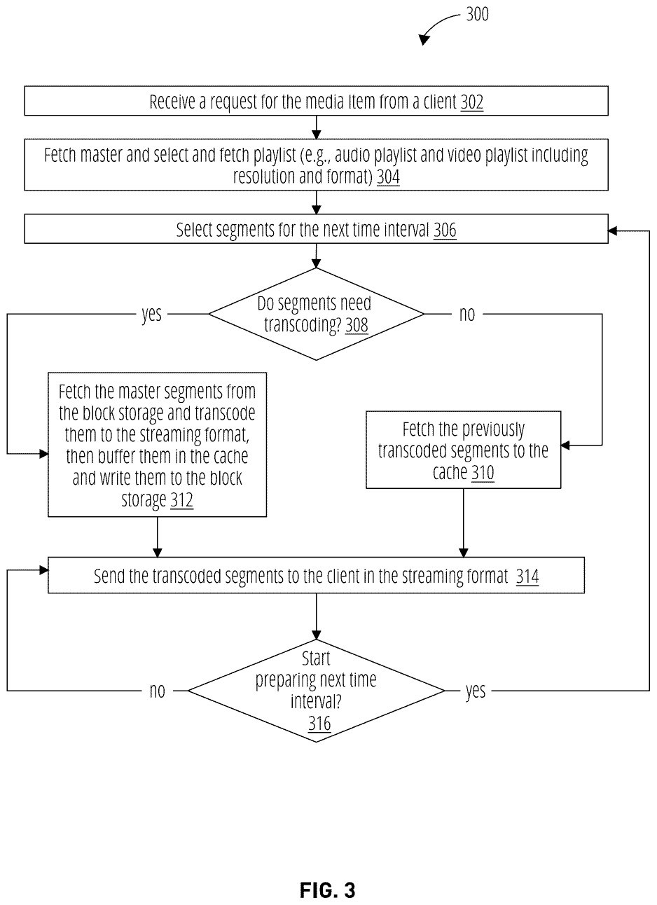

FIG. 3 illustrates an example method 300 for transcoding and streaming a video file that has previously been uploaded and may or may not have segments that have been transcoded from the original format to the streaming format. Although the example method 300 depicts a particular sequence of operations, the sequence may be altered without departing from the scope of the present disclosure. For example, some of the operations depicted may be performed in parallel or in a different sequence that does not materially affect the function of method 300. In other examples, different components of an example device or system that implements method 300 may perform functions at substantially the same time or in a specific sequence.

According to some examples, step 302 of the method includes receiving a request for the media item from a client device. For example, content management system 102 illustrated in FIG. 2 may receive a request for a media item from a client.

According to some examples, step 304 of the method includes fetching the master and providing a list of the playlists, which indicate different resolutions (e.g., an HLS ladder that include 1080P, 720P, and 480P). A video playlist corresponding to the resolution of the video player can be selected that corresponds to the resolution and format of the media/video player. Further, step 304 of the method includes fetching the selected HLS playlist (e.g., audio playlist and video playlist), which can include embedded API calls to respective segments/chunks of the video file. For example, service-management server 206 illustrated in FIG. 2 may fetch the master file, which can be in the original format (e.g., a high-resolution video such as 1080P using a standardized image compression method). Service-management server 206 can then select a playlist based on the resolution and format of the video player. Service-management server 206 can send the selection to file-management server 208 to fetch the playlist which can include API calls. For example, a first API call can be to a first part of the video such that, in response to this API call video data corresponding to the first part of the video are fetched from block storage and pre-warmed/transcoded to provide a preview and/or to allow the video to promptly start playing as soon as a play function is selected on the video player.

For example, when the video file has been previously transcoded to the streaming format and stored, the API calls can be instructions that cause the fetching of a set of segments of the transcoded video file corresponding to a predefined time interval (e.g., a one-minute time interval), as shown in step 310. When the video file has not been previously transcoded to the streaming format, the API calls can be instructions that cause the fetching from block storage of a set of segments of the master video file corresponding to the predefined time interval and then transcoding them to the streaming format, as shown in step 312.

According to some examples, step 306 of the method includes selecting segments for the next time interval.

According to some examples, decision step 308 of the method inquires whether the segments need to be transcoded. The selected segments need to be transcoded when transcoding the master file to the streaming format is the only way to obtain a copy of the video file in the streaming format. The selected segments do not need to be transcoded when there is another way to obtain a transcoded copy in the streaming format, e.g., when a transcoded copy in the streaming format exists in cache 204, block storage 214, or when there are pending instructions to transcode the segments (e.g., two request for the same video file and the same streaming format were received simultaneously) such that a transcoded copy can be obtained by waiting for the pending instructions to finishing processing. When there is no need to transcode the segments, method 300 proceeds from decision step 308 to step 310. Otherwise, method 300 proceeds from decision step 308 to step 312.

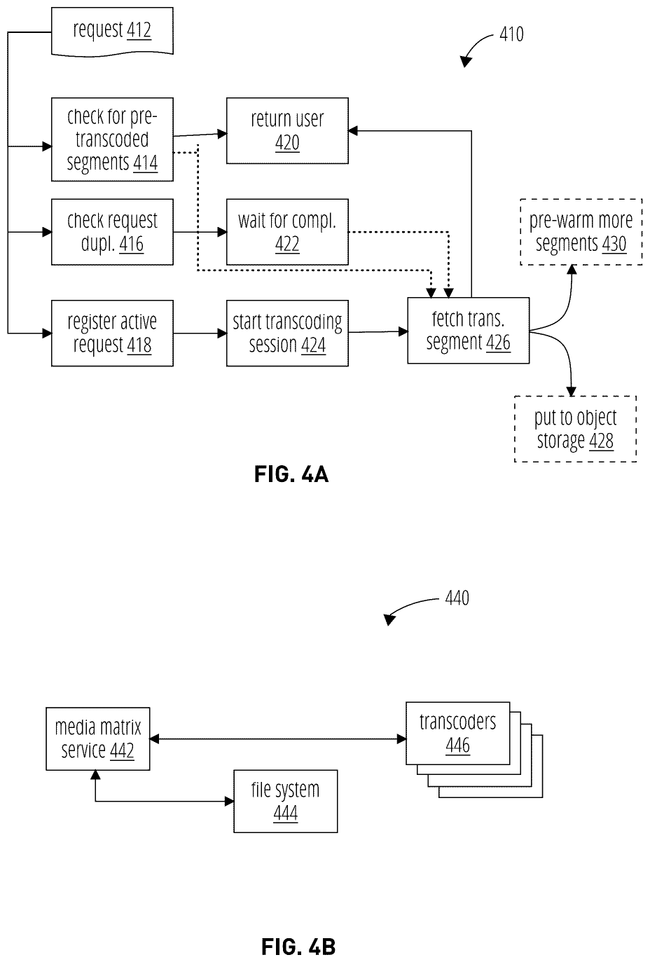

Decision step 308 can be performed by front end 212 of file-management server 208, which is shown in FIG. 4A and is discussed below.

According to some examples, step 310 of the method includes fetching the previously transcoded segments to buffer them in cache 204 in preparation for streaming the transcoded segments to client device 114. For example, file-management server 208 illustrated in FIG. 2 may fetch the previously transcoded segments from block storage 214 and store them in cache 204, thereby buffering them for streaming.

According to some examples, step 312 of the method includes fetching the master segments from the block storage and transcoding them to the streaming format. The transcoded segments can then be buffered in cache 204 before streaming them to client device 114. Then, to avoid the additional computational burden of transcoding the same segments again in the future, the transcoded segments can be stored in cache 204 for a pre-set period.

According to some examples, step 314 of the method includes sending the transcoded segments to the client in the streaming format.

According to some examples, decision step 316 of the method inquires whether it is time to start pre-warming the segments for the next time interval. When it is time to start pre-warming the segments for the next time interval, method 300 proceeds for decision step 316 to step 306, which can occur when the amount remaining segments in the buffer that have yet to be streamed falls below a predefined threshold (e.g., segments amounting thirty seconds worth of streaming). Otherwise, method 300 proceeds for decision step 316 to step 314, thereby continuing to stream the buffered segments until the predefined threshold is reached.

FIG. 4A illustrates a non-limiting example of a front end flow 410 for front end 212 of file-management server 208. File-management servers 208 can receive request 412 from service-management server 206. Request 412 can specify a series of segments of a video file and a streaming format.

Check for pre-transcribed segments 414 can inquire whether an existing copy of the transcoded segments in the streaming format can be obtained from cache 204. For example, when a copy of the segments was recently accessed, they may still be in cache 204 for a predetermined time (e.g., 24 hours) until the copy is cleared from cache 204. When a copy of the segments exists, the copy is fetched (e.g., fetch transcoded segment 426) and the fetched copy is returned (e.g., return user 420).

Generally, pre-transcribed segments are stored in cache 204 and not in block storage 214. However, if pre-transcribed segments are stored in block storage 214, check pre-transcribed segments 414 can inquire whether an existing copy of the transcoded segments in the streaming format can be obtained from block storage 214.

Check request duplication 416 inquires whether there are pending instructions to transcode the segments (e.g., two requests for the same video file and the same streaming format were received simultaneously) such that a transcoded copy can be obtained by waiting for the pending instructions to finish processing. In this case, front end 212 is instructed to wait for completion 422, fetch transcoded segment 426, and return user 420.

Register active request 418 occurs when transcoding the master file to the streaming format is the only way to obtain a copy of the video file in the streaming format. In this case, front end 212 is instructed to start a transcoding session (start transcoding session 424) and to fetch the transcoded segment that resulted from the transcoding session (fetch transcoded segment 426).

The transcoded segment is then returned to the requester (return user 420). For example, the transcoded segment can be returned to service-management server 206 before ultimately being streamed back to the client device 114.

Return user 420 is returning the transcoded segments to the requester (e.g., to service-management server 206 and ultimately streaming them back to the client device 114.

In put to object storage 428, the transcoded segments can be temporarily stored in cache 204 (also referred to as object storage) to avoid the computational burden of transcoding the same segments again shortly after they have been transcoded.

Pre-warm more segments 430 can be performed when the result of decision step 316 is yes as discussed above.

FIG. 4B illustrates a non-limiting example of a back end flow 440 of back end 210 of file-management server 208. Media matrix service 442 receives from front end 212 the instructions to start transcoding session 424. In response, file system 444 determines the location of the segments to be transcoded and fetches them from block server 218. Transcoders 446 then perform the transcoding functions. For example, transcoders 446 can be virtual machines or secure lightweight constrainers running transcoding software such as FFMPEG. According to certain non-limiting examples, transcoders 446 can be Linux containers (LXC) or unprivileged LXC (ULXC) that is restricted to user space and has no direct access to the kernel to provide enhanced security.

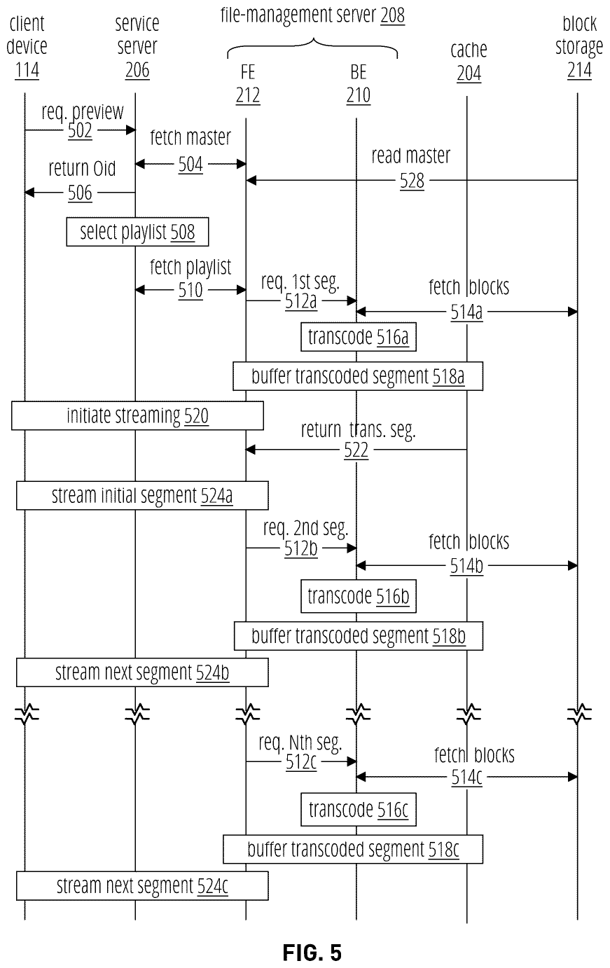

FIG. 5 illustrates a non-limiting example of a sequence diagram for an implementation of method 300 in which there are no previously trans-coded segments of the video file in the streaming format.

Client device 114 sends a request (request preview 502) to service-management server 206 requesting a preview to be generated of the video file in the streaming format.

Service-management server 206 sends instructions (fetch master 504) to fetch the master video file, and service-management server 206 selects for the fetched master the streaming format corresponding to a video player, which is used to fetch the playlist for the master.

In response to fetch master 504, front end 212 reads the master video file from block storage 214 (read master 528).

An object ID (Oid) for the video file is returned to client device 114 as part of the communications for return Oid 506.

Then, in operations select playlist 508, a selection corresponding to the streaming format is selected from the playlist. The selection from the playlist can include API calls, as discussed above.

In fetch playlist 510, the API calls are used to request that segments corresponding to a first time interval of the video file be pre-warmed, resulting in front end 212 sending instructions (e.g., request segment 512a) to back end 210 to request segments for the first time interval.

Back end 210 fetches the master segments from block storage 214 (fetch blocks 514a) and transcodes them to the streaming format (transcode segment 516a).

The transcoded segments are then stored where they can be used for streaming (buffer transcoded segment 518a). For example, as illustrated by fetch transcoded segment 426 in FIG. 4A, the transcoded segments can be fetched to front end 212 where they are returned to the user (return user 420). The transcoded segments can be stored in cache 204 for a pre-set period (e.g., 24 hours), and when they have not been used within the pre-set period, the transcoded segments are expunged from memory.

The request for the preview (request preview 502) can be started, for example, when the user opens a folder in an application that includes a video player. The streaming of the video file may not occur until the user selects the video file to initiate streaming 520.

According to certain non-limiting examples, cache 204 sends the pre-warmed segments to front end 212 (return pre-warmed segment 522), and front end 212, service-management server 206, or a combination thereof streams pre-warmed segments to client device 114 (stream segment 524a).

Once the duration of the buffered segments that remain to be streamed falls below a predefined threshold (e.g., less than thirty seconds worth of buffered segments), the pre-warming process begins again for the second time interval of the video file. That is, front end 212 requests the video segments for the second time interval (request segment 512b). Back end 210 fetches the master segments from block storage 214 (fetch blocks 514b) and transcodes them to video segments in the streaming format (transcode segment 516b) which are then buffered/stored (buffer transcoded segment 518b) so they can be streamed to client device 114 (stream segment 524b).

This process repeats again and again until the Nth time interval when front end 212 requests the video segments for the Nth time interval (request segment 512c). Back end 210 fetches the master segments from block storage 214 (fetch blocks 514c) and transcodes them to video segments in the streaming format (transcode segment 516c) which are then buffered/stored (buffer transcoded segment 518c) so they can be streamed to client device 114 (stream segment 524c).

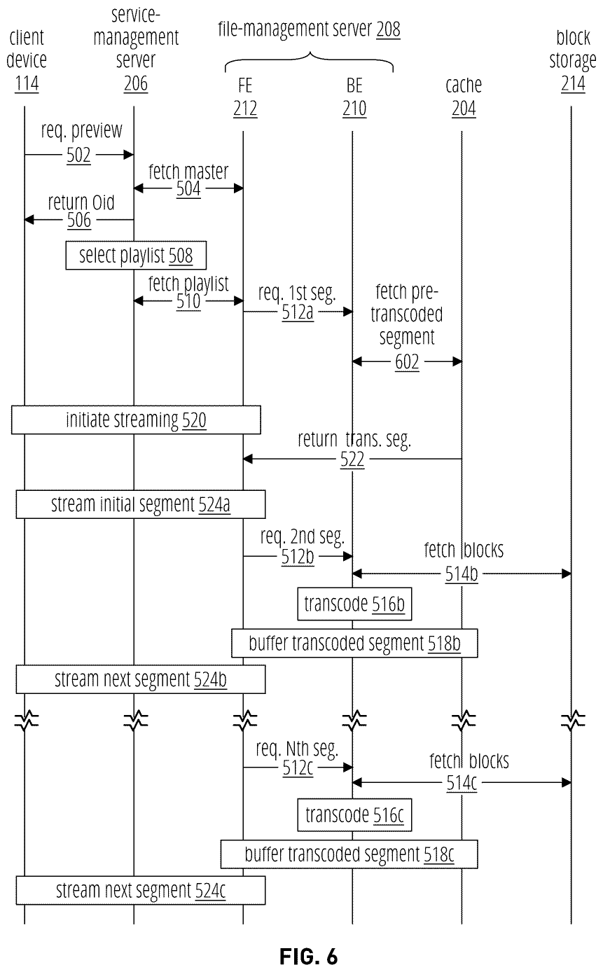

FIG. 6 illustrates a non-limiting example of a sequence diagram for an implementation of method 300. FIG. 6 is similar to FIG. 5, except the video segments for the first time interval have been previously transcoded in the streaming format. Front end 212 can whether there are already pre-transcoded video segments in cache 204, as discussed above for 414 in FIG. 4A. If there are not pre-transcoded segments, file-management server 208 uses fetch blocks 514 to fetch segments of the master from storage block 214. When there are pre-transcoded segments, front end 212 requests the video segments for the first time interval (request segment 512a), the pre-transcoded segments are fetched from cache 204 (fetch pre-transcoded segment 602), as opposed to fetching the master video segments (fetch blocks 514a). Because the fetched video segments are already transcoded, these segments do not require transcoding (omitting transcode segment 516a), and the segments can be buffered in file-management server 208 until they are used for streaming.

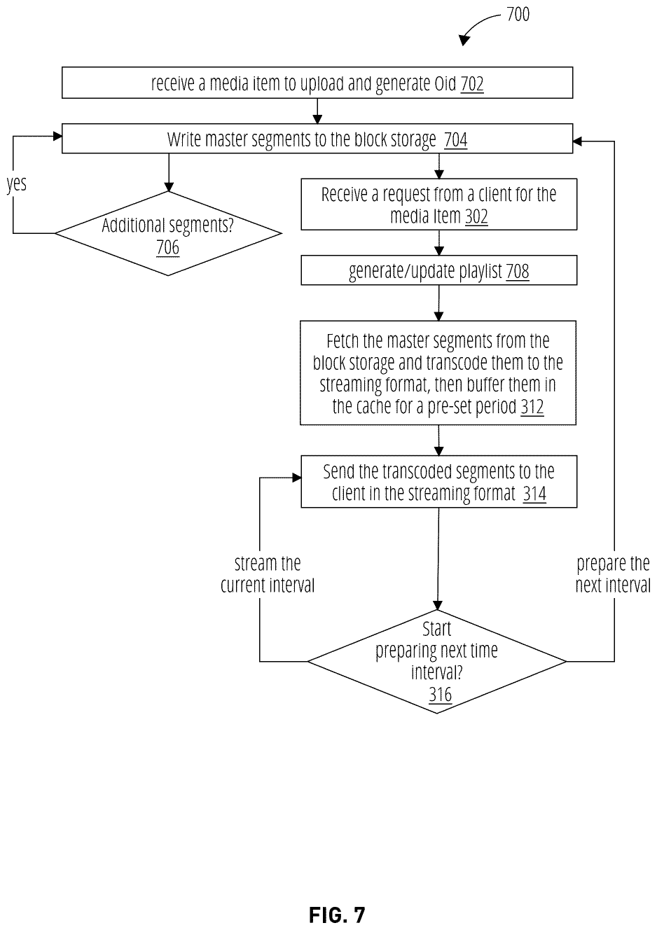

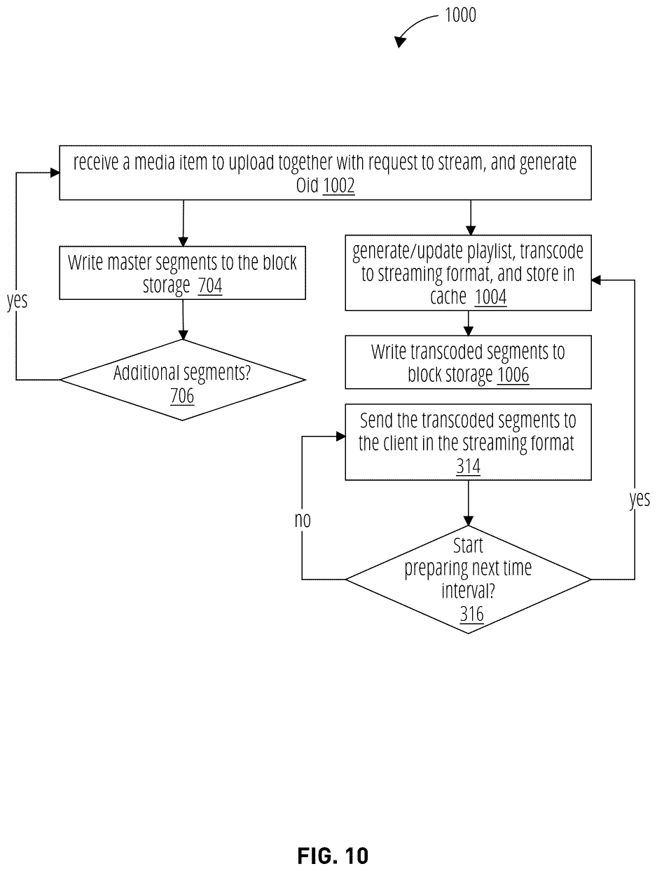

FIG. 7 and FIG. 10 illustrate two examples in which streaming of the video file occurs concurrently with the file being uploaded. In the example in FIG. 7, the request to stream the video occurs sometime after the upload of the master starts but before the upload finishes. In the example in FIG. 7, the request to stream the video is sent together with the instruction to upload the master video file, which may happen, for example, when a video conference is being recorded/uploaded and streamed simultaneously.

FIG. 7 illustrates a method 700 for transcoding and streaming a video file while it is being uploaded. Although the example method 700 depicts a particular sequence of operations, the sequence may be altered without departing from the scope of the present disclosure. For example, some of the operations depicted may be performed in parallel or in a different sequence that does not materially affect the function of method 700. In other examples, different components of an example device or system that implements method 700 may perform functions at substantially the same time or in a specific sequence.

According to some examples, step 702 of the method includes receiving a media item to upload. Further, step 702 of the method includes generating an object ID (Oid) similar to the communications for return Oid 506 as described for FIG. 5

According to some examples, step 704 of the method includes writing master segments to the block storage. For example, block server 218 illustrated in FIG. 2 may write master segments to step storage drive 110. Each time segments of the master video file are written to block storage 214, the playlist for the master video file can also be written/amended. In addition to writing the master video file and the playlist to block storage 214, they can also be written to cache 204 where they are accessible to file-management server 208 for processing (e.g., transcoding).

According to some examples, decision step 706 of the method inquires whether there are additional segments to upload. When there are additional segments to upload, method 700 continues to step 704.

Steps 302, 708, 312, 314, and 316 can be performed in parallel with steps 704 and 706. Steps 302, 312, 314, and 316 can be performed as described for FIG. 3.

According to some examples, step 302 of the method includes receiving a request from a client for the media item. Service-management server 206 illustrated in FIG. 2 may receive a request from a client for the media item.

According to some examples, step 708 of the method includes generating/updating the playlist. For example, service-management server 206 illustrated in FIG. 2 may generate/update playlist to include references to the transcoded segments. Step 708 can be performed after or in parallel with transcoding the segments in step 312.

According to some examples, step 312 of the method includes fetching the master segments from the block storage and transcoding them to the streaming format. Further, step 312 of the method can include buffering the transcoded segments in the cache and writing them to the block storage. For example, file-management server 208 illustrated in FIG. 2 may fetch the master segments from the block storage and transcode them to the streaming format, then buffer them in the cache for a pre-set period.

According to some examples, step 314 of the method includes sending the transcoded segments to the client in the streaming format. For example, file-management server 208, service-management server 206, or a combination thereof may send to the client the transcoded segments in the streaming format.

According to some examples, decision step 316 of the method inquires whether it is time to start pre-warming the segments for the next time interval. When it is time to start pre-warming the segments for the next time interval, method 700 proceeds for decision step 316 to step 306, which can occur when the amount remaining segments in the buffer that have yet to be streamed falls below a predefined threshold (e.g., segments amounting thirty seconds worth of streaming). Otherwise, method 700 proceeds for decision step 316 to step 314, thereby continuing to stream the buffered segments until the predefined threshold is reached.

FIG. 8 illustrates an example of an uploaded video file 802 that has been partitioned into segments, including header 804, segment 808a, segment 808b, segment 808c, segment 808d, segment 808e, segment 808f, and segment 808g. The segments can have different lengths/durations. For example, 808a has a duration of two seconds and segment 808b has a duration of one second. Upload segment boundaries 806 are selected to occur between segments, which enables the segments to be processed/transcoded immediately after they are uploaded. If upload segment boundaries 806 bisect a segment into two different upload portions, then the entire file (e.g., uploaded video file 802) would need to be uploaded before the video file could be transcoded. Upload segment boundaries 806 partition the segments into upload portions of varying length (e,g., upload 810a is 0.5 MB, upload 810b is 3 MB, upload 810c is 2 MB, upload 810d is 4 MB, upload 810e is 2 MB, upload 810f is 2 MB, and upload 810g is 2 MB).

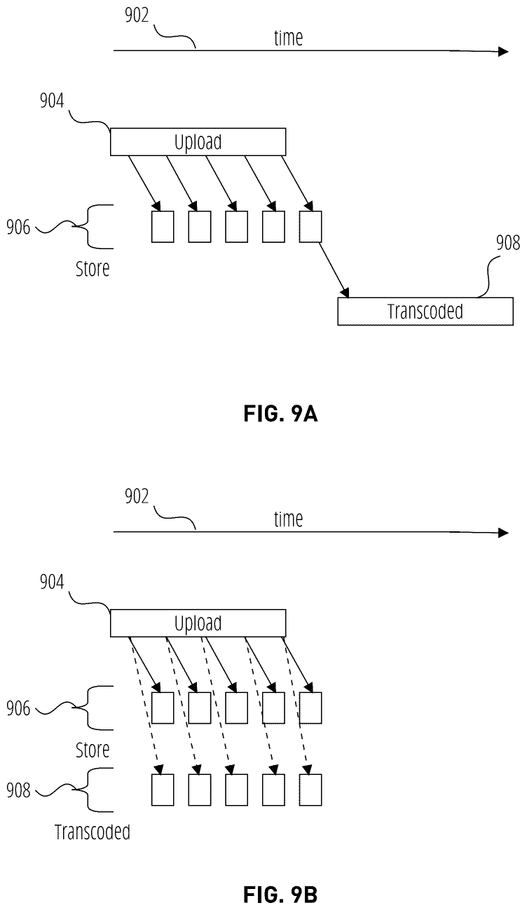

FIG. 9A and FIG. 9B illustrate the benefit of placing upload segment boundaries 806 between the video segments. FIG. 9A illustrates the case in which upload segment boundaries 806 are not placed between the video segments, and FIG. 9B illustrates the case in which upload segment boundaries 806 are placed between the video segments.

In FIG. 9A, as time 902 increases, the segments of the upload 904 are uploaded in packets of uniform size to block storage 214 (store 906), resulting in respective video segments being split between upload packets. The video file is then transcoded (transcoded 908) only after all of the packets have been uploaded.

In FIG. 9B, as time 902 increases, upload segment boundaries 806 are placed between the video segments such that the segments of the upload 904 are uploaded to block storage 214 (store 906) in variable size packets corresponding to a discrete number of segments. Thus, each segment can be transcoded (transcoded 908) as soon as the packet it is in has been uploaded.

FIG. 10 illustrates a second example method 1000 for transcoding and streaming a video file while it is being uploaded. Although the example method 1000 depicts a particular sequence of operations, the sequence may be altered without departing from the scope of the present disclosure. For example, some of the operations depicted may be performed in parallel or in a different sequence that does not materially affect the function of method 1000. In other examples, different components of an example device or system that implements method 1000 may perform functions at substantially the same time or in a specific sequence.

According to some examples, step 1002 of the method includes receiving a media item to upload together with a request to stream the uploaded video file to client device 114 in a streaming format. Further, step 1002 of the method includes generating an object ID (Oid) similar to the communications for return Oid 506 as described for FIG. 5.

Step 704 and decision step 706 can be performed as described in FIG. 7.

According to some examples, step 1004 of the method includes generating/updating the playlist, transcoding segments of the uploaded master file to the streaming format. Further, step 1004 of the method includes storing the updated playlist and the transcoded segments in the cache. For example, service-management server 206 illustrated in FIG. 2 may generate/update the playlist, transcode segments of the uploaded master file to the streaming format, and store the updated playlist and the transcoded segments in cache 204.

According to some examples, step 1006 of the method includes writing transcoded segments to the block storage. For example, file-management server 208 illustrated in FIG. 2 may write transcoded segments to block storage 214.

According to some examples, the method includes sending the transcoded segments to the client in the streaming format. For example, file-management server 208, service-management server 206, or a combination thereof may send to the client the transcoded segments in the streaming format.

According to some examples, decision step 316 of the method inquires whether it is time to start pre-warming the segments for the next time interval. When it is time to start pre-warming the segments for the next time interval, method 1000 proceeds for decision step 316 to step 1004, which can occur when the amount remaining segments in the buffer that have yet to be streamed falls below a predefined threshold (e.g., segments amounting thirty seconds worth of streaming). Otherwise, method 1000 proceeds for decision step 316 to step 314, thereby continuing to stream the buffered segments until the predefined threshold is reached.

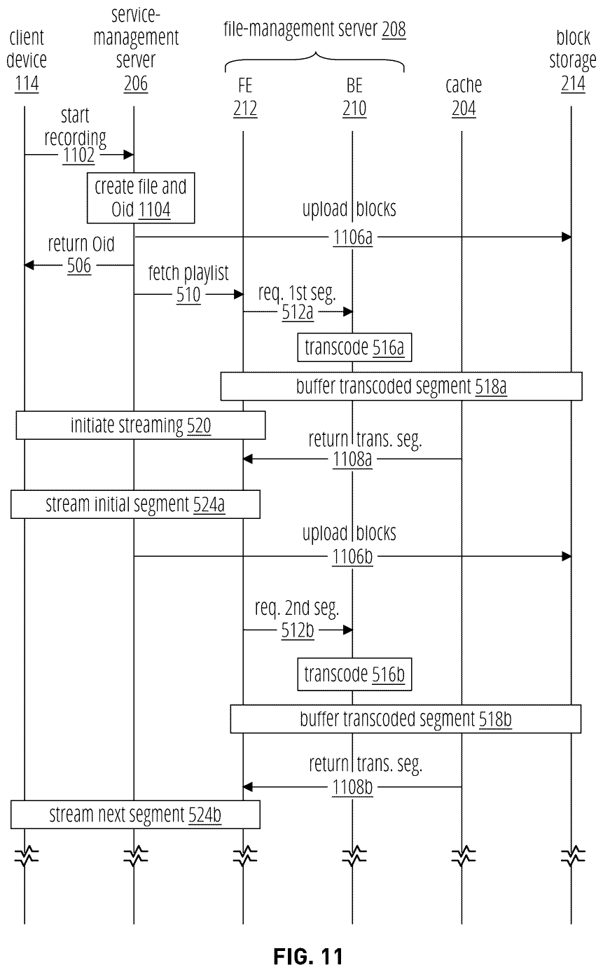

FIG. 11 illustrates a sequence diagram implementing method 1000. Similar to request preview 502, the uploading and streaming process illustrated in FIG. 11 can be initiated when a recording is started (start recording 1102), which causes a video file to be uploaded (i.e., the master file) and to simultaneously be transcoded to the streaming format and streamed to client device 114. In response to start recording 1102, service-management server 206 creates a file and an object ID (create file and Oid 1104), which is returned to client device 114 (return Oid 506).

Most of the communications and processes can be performed as described above for FIG. 5. The primary difference is that the master file must be uploaded to content management system 102 before it can be transcoded and streamed to client device 114. According to certain non-limiting examples, the master video segments can be uploaded to block storage 214 while simultaneously being stored in cache 204 for transcoding.

Another minor difference is that the playlist for the master video file is being generated/updated and stored in memory (e.g., cache 204 and storage drive 110) as the packets of the master video file are being uploaded (e.g., upload blocks 1106a and upload blocks 1106b). Further, the transcoded segments can be fetched from cache 204 to front end 212 as needed for streaming (return pre-warmed segment 1108a and return pre-warmed segment 1108b). In this non-limiting example, the master segments from uploaded packets as transcoded and streamed as they are upload, rather than waiting for the entire video file to be uploaded. These features are enabled by placing upload segment boundaries 806 between the video segments as discussed for FIG. 8.

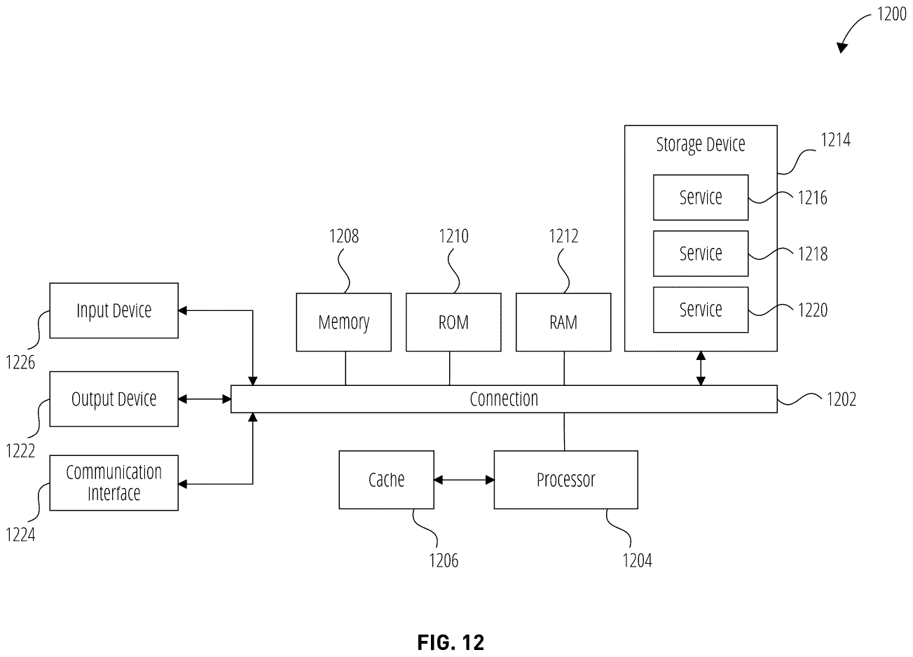

FIG. 12 shows an example of computing system 1200, which can be, for example, any computing device making up any of the servers or other computational units of content management system 102 illustrated in FIG. 2 or any component thereof (e.g., service-management server 206, file-management server 208, and block server 218) in which the components of the system are in communication with each other using connection 1202. Computing system 1200 can implement method 300, method 700, and/or method 1000. Connection 1202 can be a physical connection via a bus, or a direct connection into processor 1204, such as in a chipset architecture. Connection 1202 can also be a virtual connection, networked connection, or logical connection.

In some embodiments, computing system 1200 is a distributed system in which the functions described in this disclosure can be distributed within a data center, multiple data centers, a peer network, etc. In some embodiments, one or more of the described system components represents many such components each performing some or all of the function for which the component is described. In some embodiments, the components can be physical or virtual devices.

Example computing system 1200 includes at least one processing unit (e.g., processor 1204) and connection 1202 that couples various system components including system memory 1208, such as read-only memory (e.g., ROM 1210) and random access memory (e.g., RAM 1212) to processor 1204. Computing system 1200 can include a cache of high-speed memory 1206 connected directly with, in close proximity to, or integrated as part of processor 1204.

Processor 1204 can include any general-purpose processor and a hardware service or software service, such as service 1216, service 1218, and service 1220 stored in storage device 1214, configured to control processor 1204 as well as a special-purpose processor where software instructions are incorporated into the actual processor design. Processor 1204 may essentially be a completely self-contained computing system, containing multiple cores or processors, a bus, a memory controller, a cache, etc. A multi-core processor may be symmetric or asymmetric.

To enable user interaction, computing system 1200 includes an input device 1226, which can represent any number of input mechanisms, such as a microphone for speech, a touch-sensitive screen for gesture or graphical input, keyboard, mouse, motion input, speech, etc. Computing system 1200 can also include output device 1222, which can be one or more of a number of output mechanisms known to those of skill in the art. In some instances, multimodal systems can enable a user to provide multiple types of input/output to communicate with computing system 1200. Computing system 1200 can include communication interface 1224, which can generally govern and manage the user input and system output. There is no restriction on operating on any particular hardware arrangement, and therefore the basic features here may easily be substituted for improved hardware or firmware arrangements as they are developed.

Storage device 1214 can be a non-volatile memory device and can be a hard disk or other types of computer-readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 1214 can include software services, servers, services, etc., that when the code that defines such software is executed by the processor 1204, it causes the system to perform a function. In some embodiments, a hardware service that performs a particular function can include the software component stored in a computer-readable medium in connection with the necessary hardware components, such as processor 1204, connection 1202, output device 1222, etc., to carry out the function.

### Additional Considerations

The foregoing described embodiments have been presented for the purpose of illustration; they are not intended to be exhaustive or to limiting to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, described modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may include one or more general-purpose computing devices selectively activated or reconfigured by one or more stored computer programs. A computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Described embodiments may also relate to a product that is produced by a computing process described herein. Such a product may include information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

### Aspects

The present technology includes computer-readable storage mediums for storing instructions, and systems for executing any one of the methods embodied in the instructions addressed in the aspects of the present technology presented below:

Aspect 1. A method of transcoding video data, the method comprising: storing, at a content management system, a master of a video content item, the master having a first format including a first resolution and a first video compression format; receiving a request to stream to a client device the video content item using a second format; fetching a first set of video segments of the master; transcoding the first set of video segments from the first format to the second format to provide first transcoded segments; streaming the first transcoded segments to the client device; fetching a second set of video segments of the master after part but not all the first transcoded segments have been streamed, the second set of video segments coming after the first set of video segments; transcoding the second set of video segments from the first format to the second format to provide second transcoded segments; and streaming the second transcoded segments to the client device after the first transcoded segments have been streamed.

Aspect 2. The method of aspect 1, further comprising: fetching a third set of video segments of the master after part but not all the second transcoded segments have been streamed to, the third set of video segments coming after the second set of video segments; transcoding the third set of video segments from the first format to the second format to provide third transcoded segments; and streaming the third transcoded segments to the client device after the second transcoded segments have been streamed.

Aspect 3. The method of aspect 1, wherein in the video content item, the second set of video segments comes immediately after the first set of video segments, and transcoding the second set of video segments from the first format to the second format to provide second transcoded segments after part but not all the first transcoded segments have been streamed

Aspect 4. The method of aspect 1, wherein: video segments of the master comprises a plurality of sets of video segments including the first set of video segments and the second set of video segments, and the method further comprises: fetching respective sets of video segments of the plurality of sets of video segments in increments of respective video segments, durations of the respective sets of video segments being based on a first time duration, and fetching and transcoding a next increment of the plurality of sets of video segments, when a duration of remaining transcoded segments to be streamed is less than a second time duration, wherein the remaining transcoded segments to be streamed include video segments of the master that been transcoded to the second format but have not been streamed to the client device.

Aspect 5. The method of aspect 4, further comprising: fetching the respective sets of video segments from a block storage to a cache memory; and buffering respective transcoded segments in the cache memory of the content management system while waiting for the respective transcoded segments to be streamed to the client device.

Aspect 6. The method of aspect 1, further comprising: determining that a cache memory of the content management system stores one or more transcoded segments of the video content item in the second format; and streaming the one or more transcoded segments to the client device without fetching and transcoding the video segments of the master corresponding to the one or more transcoded segments.

Aspect 7. The method of aspect 1, further comprising: restricting the transcoding, which is performed in response to the request to stream to the client device the video content item, to transcoding the video segments of the master from the first format to the second format without also transcoding the video segments of the master from the first format to a third format.

Aspect 8. The method of aspect 1, further comprising: uploading, to the content management system, the video segments of the master in upload units having upload boundaries between the upload units occur between the video segments of the master without intersecting a video segment of the master; and before all of the video segments of the master have been uploaded, transcoding some of the video segments of the master from the first format to the second format to provide some transcoded segments and streaming the some transcoded segments to the client device.

Aspect 9. The method of aspect 1, wherein: storing the master of the video includes storing the video segments of the master, which have been uploaded to the content management system, in storage blocks that are indexed individually, such that at least one storage block can be fetched while one or more video segments of the master have not yet been uploaded, fetching the at least one storage block, while the one or more video segments of the master have not yet been uploaded, transcoding the video segments of the at least one storage block, while the one or more video segments of the master have not yet been uploaded, to provide a first set of transcoded segments, and streaming the transcoded segments includes streaming the first set of transcoded segments, while the one or more video segments of the master have not yet been uploaded.

Aspect 10. The method of aspect 1, further comprising: generating a playlist of the video content item in response to receiving the request to stream the video content item, wherein the playlist includes indicia of a second resolution and a second video-compression format corresponding the second format, and the playlist includes at least one of a service request or an application programming interface (API) call to pre-warm an initial portion of the master of the video content item in the second format.

Aspect 11. A method of transcoding video data, the method comprising: storing, at a content management system, a master of a video content item, the master having a first format including a first resolution and in a first video compression format; receiving a first request to generate a preview of the video content item in a second format to a client device; fetching respective sets of video segments of the master in increments, wherein the respective sets include a first set of the video segments and a second set of the video segments, the first set of the video segments comes before a second set of the video segments, and the second set is fetched when some but not all of the first set video segments has been streamed to the client device; and transcoding from the first format to the second format the respective sets of video segments as they are fetched to provide transcoded segments for the respective set of the video segments, wherein an initial set of the video segments of video of the master is fetched and transcoded in response to the first request, and subsequent sets of the video segments of video of the master are fetched and transcoded after at least part of transcoded segments of the initial set of the video segments have been streamed to the client device.

Aspect 12. The method of aspect 11, wherein: a video-play duration of the respective sets of video segments corresponds to a first time duration, the second set is fetched when some but not all of the transcoded segments of the first set video segments have been streamed to the client device and another time duration of remaining transcoded video segments of the first set video segments is less than a second time duration, wherein the remaining transcoded video segments are transcoded video segments of the first set video segments that remain to be streamed to the client device, and the second first time duration is shorter than the first time duration.

Aspect 13. The method of aspect 11 or aspect 12, further comprising: receiving a second request to stream the video content item in the second format to the client device; and stream, in response to the second request, the transcoded segments to the client device.

Aspect 14. The method of any of aspects 11-13, further comprising: checking whether a cache memory or a block storage of the content management system already stores one or more transcoded segments of the video content item in the second format; and streaming the one or more transcoded segments that is already stored to the client device.

Aspect 15. The method of any of aspects 11-14, further comprising: uploading the video segments of the master in upload units such that upload boundaries between the upload units occur between the master without intersecting a video segment of the master; and before all of the video segments of the master have been uploaded, transcode some of the video segments of the master from the first format to the second format to provide some transcoded segments and stream the some transcoded segments to the client device.

Aspect 16. The method of any of aspects 11-15, further comprising: generating a playlist of the video content item in response to receiving the first request, wherein the playlist includes indicia of a second format comprising a second resolution and a second video-compression format, and the playlist includes at least one of a service request or an application programming interface (API) call to pre-warm an initial portion of the master of the video content item in the second format.

Aspect 17. A method of transcoding video data, the method comprising: pre-warming a video content item stored at a content management system by generating and storing in a buffer first transcoded segments for a first set of the video segments of a master of the video content item, wherein the content management system stores the master in a first format comprising a first resolution and a first video compression format, and the first transcoded segments are generated by transcoding the first set of the video segments from the first format to a second format that is used for streaming to a client device; generating and store, in the buffer, subsequent transcoded segments corresponding to subsequent sets of the video segments of the master, durations of the subsequent sets of the video segments being based on a first time duration, the subsequent sets of the video segments including a first set and a second set, and transcoding the second set is paused until a remaining part of the subsequent transcoded segments of the first set corresponds to a duration that is less than a second time duration, the remaining part being the subsequent transcoded segments of the first set that is stored in the buffer and remains to be streamed to the client device; and streaming the transcoded segments to the client device in response to the client device sending an instruction to stream the video content item.

Aspect 18. The method of aspect 17, further comprising: uploading, to the content management system, the master of a video content item, the master and storing the master in memory blocks of a block storage; receiving a request to stream the video content item to the client device; fetching memory blocks corresponding to the subsequent sets of the video segments by waiting until a subsequent set of the video segments is one of one or more next sets to be transcoded to fetch the memory blocks corresponding to the subsequent from the block storage to a cache memory; and buffering the transcoded segments in the cache memory while waiting for the transcoded segments to be streamed to the client device.

Aspect 19. The method of aspect 17 or aspect 18, further comprising: determining that a cache memory of the content management system stores one or more transcoded segments of the video content item in the second format; and fetching from the cache memory and streaming the one or more transcoded segments to the client device without fetching and transcoding video segments of the master corresponding to the one or more transcoded segments.

Aspect 20. The method of any of aspects 17-19, further comprising: determining that pending instructions in the content management system will generate one or more transcoded segments of the video content item in the second format; waiting for the pending instructions to be processed thereby generating the one or more transcoded segments; and streaming the one or more transcoded segments that were generated based on the pending instructions.

Aspect 21. The method of any of aspects 17-20, further comprising: uploading the video segments of the master in upload units such that upload boundaries between the upload units occur between the segments without intersecting a video segment of the master; and before all of the video segments of the master have been uploaded, transcoding the first set of the video segments from the first format to the second format to provide some transcoded segments and stream the some transcoded segments to the client device.

Aspect 22. A method of transcoding video data, the method comprising: storing, at a content management system, a master of a video file, the master having a first format including a first resolution and in a first video compression format; receiving a request to stream the video file in a second format to a client device; fetching respective sets of video segments of the master in increments corresponding to a first time duration, a respective set of the video segments having a video-play duration defined by the first time duration, wherein a first set of the video segments comes before a second set of the video segments, and the second set is fetched after an amount of the first set video segments remaining to be streamed to the client device is less than a second time duration; transcoding from the first format to the second format the respective sets of video segments as they are fetched to provide transcoded segments for the respective set of the video segments; and streaming the transcoded segments to the client device.

Aspect 23. The method of aspect 22, further comprising: fetching the respective sets of video segments from a block storage to a cache memory; and buffering the transcoded segments in the cache memory of the content management system while waiting for the transcoded segments to be streamed to the client device.

Aspect 24. The method of aspect 22 or aspect 23, further comprising: checking whether a cache memory or a block storage of the content management system stores one or more transcoded segments of the video file in the second format; and streaming the stored one or more transcoded segments to the client device without fetching and transcoding the segment of the master corresponding to the one or more transcoded segments.

Aspect 25. The method of any of aspects 22-24, wherein the second first time duration is shorter than the first time duration.

Aspect 26. The method of any of aspects 22-25, wherein a file service of the content management system manages the fetching and transcoding of the respective sets of the video segments.

Aspect 27. The method of any of aspects 22-26, wherein transcoding that is performed in response to the request is limited to transcoding the video segments of the master from the first format to the second format without also transcoding the video segments of the master from the first format to a third format.

Aspect 28. The method of any of aspects 22-27, further comprising: uploading the video segments of the master in upload units such that upload boundaries between the upload units occur between the segments and not within any of the video segments; and transcoding, before all of the video segments of the master have been uploaded, some of the video segments of the master from the first format to the second format to provide some transcoded segments and streaming the some transcoded segments to the client device.

Aspect 29. The method of any of aspects 22-28, wherein: storing the master of the video includes uploading the video segments of the master and storing the video segments of the master in storage blocks that are indexed individually, such that at least one storage block can be fetched while one or more video segments of the master have not yet been uploaded, fetching the at least one storage block while the one or more video segments of the master have not yet been uploaded, and transcoding the video segments of the at least one storage block while the one or more of the master have not yet been uploaded to provide a first set of transcoded segments, and streaming the transcoded segments includes streaming the first set of transcoded segments while the one or more of the master have not yet been uploaded.

Aspect 30. The method of any of aspects 22-29, further comprising: generating a playlist of the video file in response to receiving the request to preview and/or play the video file, wherein the playlist includes indicia of a second resolution and a second video-compression format corresponding the second format, and the playlist includes one or more service requests and or application programming interface (API) calls to obtain a beginning portion of the master of the video file to the resolution and the format corresponding the video player.

Aspect 31. A computing apparatus comprising: one or more processors; and a memory storing instructions that, when executed by the processor, configure the computing apparatus to perform the method of any of aspects 1-30.

Aspect 32. A non-transitory computer-readable storage medium, the computer-readable storage medium including instructions that when executed by a computer, cause the computer to perform the method of any of aspects 1-30.

1. A method of transcoding video data, the method comprising:
storing, at a content management system, an uploaded version of a video content item, the uploaded version having a first format including a first resolution and a first video compression format;
receiving a request to stream to a client device the video content item using a second format;
fetching a first set of video segments of the uploaded version;
transcoding the first set of video segments from the first format to the second format to provide first transcoded segments;
streaming the first transcoded segments to the client device;
fetching a second set of video segments of the uploaded version after part but not all the first transcoded segments have been streamed, the second set of video segments coming after the first set of video segments;
transcoding the second set of video segments from the first format to the second format to provide second transcoded segments; and
streaming the second transcoded segments to the client device after the first transcoded segments have been streamed.

2. The method of claim 1, further comprising:
fetching a third set of video segments of the uploaded version after part but not all the second transcoded segments have been streamed to, the third set of video segments coming after the second set of video segments;
transcoding the third set of video segments from the first format to the second format to provide third transcoded segments; and
streaming the third transcoded segments to the client device after the second transcoded segments have been streamed.

3. The method of claim 1, wherein:
in the video content item, the second set of video segments comes immediately after the first set of video segments, and
transcoding the second set of video segments from the first format to the second format to provide second transcoded segments after part but not all the first transcoded segments have been streamed.

4. The method of claim 1, wherein:
video segments of the uploaded version comprises a plurality of sets of video segments including the first set of video segments and the second set of video segments, and
the method further comprises:
fetching respective sets of video segments of the plurality of sets of video segments in increments of respective video segments, durations of the respective sets of video segments being based on a first time duration, and
fetching and transcoding a next increment of the plurality of sets of video segments, when a duration of remaining transcoded segments to be streamed is less than a second time duration, wherein
the remaining transcoded segments to be streamed include video segments of the uploaded version that been transcoded to the second format but have not been streamed to the client device.

5. The method of claim 4, further comprising:
fetching the respective sets of video segments from a block storage to a cache memory; and
buffering respective transcoded segments in the cache memory of the content management system while waiting for the respective transcoded segments to be streamed to the client device.

6. The method of claim 1, further comprising:
determining that a cache memory of the content management system stores one or more transcoded segments of the video content item in the second format; and
streaming the one or more transcoded segments to the client device without fetching and transcoding the video segments of the uploaded version corresponding to the one or more transcoded segments.

7. The method of claim 1, further comprising:
uploading, to the content management system, the video segments of the uploaded version in upload units having upload boundaries between the upload units occur between the video segments of the uploaded version without intersecting a video segment of the uploaded version; and
before all of the video segments of the uploaded version have been uploaded, transcoding some of the video segments of the uploaded version from the first format to the second format to provide some transcoded segments and streaming the some transcoded segments to the client device.

8. The method of claim 1, wherein:
storing the uploaded version of the video includes storing the video segments of the uploaded version, which have been uploaded to the content management system, in storage blocks that are indexed individually, such that at least one storage block can be fetched while one or more video segments of the uploaded version have not yet been uploaded,
fetching the at least one storage block, while the one or more video segments of the uploaded version have not yet been uploaded,
transcoding the video segments of the at least one storage block, while the one or more video segments of the uploaded version have not yet been uploaded, to provide a first set of transcoded segments, and
streaming the transcoded segments includes streaming the first set of transcoded segments, while the one or more video segments of the uploaded version have not yet been uploaded.

9. The method of claim 1, further comprising:
generating a playlist of the video content item in response to receiving the request to stream the video content item, wherein the playlist includes indicia of a second resolution and a second video-compression format corresponding the second format, and the playlist includes at least one of a service request or an application programming interface (API) call to pre-warm an initial portion of the uploaded version of the video content item in the second format.

10. A computing apparatus comprising:
one or more processors; and
a memory storing instructions that, when executed by the processor, configure the computing apparatus to:
store, at a content management system, an uploaded version of a video content item, the uploaded version having a first format including a first resolution and in a first video compression format;
receive a first request to generate a preview of the video content item in a second format to a client device;
fetch respective sets of video segments of the uploaded version in increments, wherein the respective sets include a first set of the video segments and a second set of the video segments, the first set of the video segments comes before a second set of the video segments, and the second set is fetched when some but not all of the first set video segments has been streamed to the client device; and
transcode from the first format to the second format the respective sets of video segments as they are fetched to provide transcoded segments for the respective set of the video segments, wherein
an initial set of the video segments of video of the uploaded version is fetched and transcoded in response to the first request, and subsequent sets of the video segments of video of the uploaded version are fetched and transcoded after at least part of transcoded segments of the initial set of the video segments have been streamed to the client device.

11. The computing apparatus of claim 10, wherein:
a video-play duration of the respective sets of video segments corresponds to a first time duration,
the second set is fetched when some but not all of the transcoded segments of the first set video segments have been streamed to the client device and another time duration of remaining transcoded video segments of the first set video segments is less than a second time duration, wherein the remaining transcoded video segments are transcoded video segments of the first set video segments that remain to be streamed to the client device, and
the second first time duration is shorter than the first time duration.

12. The computing apparatus of claim 10, wherein the instructions further configure the computing apparatus to:
receive a second request to stream the video content item in the second format to the client device; and
stream, in response to the second request, the transcoded segments to the client device.

13. The computing apparatus of claim 10, wherein the instructions further configure the computing apparatus to:
check whether a cache memory or a block storage of the content management system already stores one or more transcoded segments of the video content item in the second format; and
stream the one or more transcoded segments that is already stored to the client device.

14. The computing apparatus of claim 10, wherein the instructions further configure the computing apparatus to:
upload the video segments of the uploaded version in upload units such that upload boundaries between the upload units occur between the uploaded version without intersecting a video segment of the uploaded version; and
before all of the video segments of the uploaded version have been uploaded, transcode some of the video segments of the uploaded version from the first format to the second format to provide some transcoded segments and stream the some transcoded segments to the client device.

15. The computing apparatus of claim 10, wherein the instructions further configure the computing apparatus to:
generate a playlist of the video content item in response to receiving the first request, wherein the playlist includes indicia of a second format comprising a second resolution and a second video-compression format, and the playlist includes at least one of a service request or an application programming interface (API) call to pre-warm an initial portion of the uploaded version of the video content item in the second format.

16. A non-transitory computer-readable storage medium, the non-transitory computer-readable storage medium including instructions that when executed by a computing system, cause the computing system to:
pre-warm a video content item stored at a content management system by generating and storing in a buffer first transcoded segments for a first set of the video segments of an uploaded version of the video content item, wherein the content management system stores the uploaded version in a first format comprising a first resolution and a first video compression format, and the first transcoded segments are generated by transcoding the first set of the video segments from the first format to a second format that is used for streaming to a client device;
generate and store, in the buffer, subsequent transcoded segments corresponding to subsequent sets of the video segments of the uploaded version, durations of the subsequent sets of the video segments being based on a first time duration, the subsequent sets of the video segments including a first set and a second set, and transcoding the second set is paused until a remaining part of the subsequent transcoded segments of the first set corresponds to a duration that is less than a second time duration, the remaining part being the subsequent transcoded segments of the first set that is stored in the buffer and remains to be streamed to the client device; and
stream the transcoded segments to the client device in response to the client device sending an instruction to stream the video content item.

17. The non-transitory computer-readable storage medium of claim 16, wherein the instructions further cause the computing system to:
upload, to the content management system, the uploaded version of a video content item, the uploaded version and store the uploaded version in memory blocks of a block storage;
receive a request to stream the video content item to the client device;
fetch memory blocks corresponding to the subsequent sets of the video segments by waiting until a subsequent set of the video segments is one of one or more next sets to be transcoded to fetch the memory blocks corresponding to the subsequent from the block storage to a cache memory; and
buffer the transcoded segments in the cache memory while waiting for the transcoded segments to be streamed to the client device.

18. The non-transitory computer-readable storage medium of claim 16, wherein the instructions further cause the computing system to:
determine that a cache memory of the content management system stores one or more transcoded segments of the video content item in the second format; and
fetch from the cache memory and stream the one or more transcoded segments to the client device without fetching and transcoding video segments of the uploaded version corresponding to the one or more transcoded segments.

19. The non-transitory computer-readable storage medium of claim 16, wherein the instructions further cause the computing system to:
determine that pending instructions in the content management system will generate one or more transcoded segments of the video content item in the second format;
wait for the pending instructions to be processed thereby generating the one or more transcoded segments; and
stream the one or more transcoded segments that were generated based on the pending instructions.

20. The non-transitory computer-readable storage medium of claim 16, wherein the instructions further cause the computing system to:
upload the video segments of the uploaded version in upload units such that upload boundaries between the upload units occur between the segments without intersecting a video segment of the uploaded version; and
before all of the video segments of the uploaded version have been uploaded, transcode the first set of the video segments from the first format to the second format to provide some transcoded segments and stream the some transcoded segments to the client device.
